(19) United States
(12) Patent Application Publication
(10) Pub. No.: US 2026/0026420 A1
(43) Pub. Date: Jan. 29, 2026

(54) ELASTOMERIC GAUGE WHEEL

(71) Applicant: Gallagher Corporation, Gurnee, IL (US)

(72) Inventors: Richard Gallagher, Lake Bluff, IL (US); Shaun Gosselin, Fox Lake, IL (US)

(21) Appl. No.: 18/941,914

(22) Filed: Nov. 8, 2024

Related U.S. Application Data
(60) Provisional application No. 63/675,594, filed on Jul. 25, 2024.

(51) Int. Cl. A01B 35/28; B29D 30/02; B29K 75/00

(52) U.S. Cl. CPC A01B 35/28; B29D 30/02; B29K 2075/00; B29K 2995/007

(57) ABSTRACT

A gauge wheel tire includes an elastomeric ground engaging portion, a first elastomeric sidewall portion, a second elastomeric sidewall portion, and an elastomeric axial support portion that define an annular cavity. The gauge wheel tire additionally includes at least a first member, which is both flexible and resilient, positioned in the annular cavity and fixedly attached to the elastomeric ground engaging portion and/or the elastomeric axial support portion, wherein the first member has a first surface and a second surface that faces away from the first surface, and is configured and arranged so that application of a force to the elastomeric ground engaging portion along a first line that intercepts and is perpendicular to an axis of rotation of the gauge wheel tire generates a compression force within the first member adjacent the first surface and a tension force within the first member adjacent the second surface.

### CROSS-REFERENCE TO RELATED APPLICATIONS

This application claims the benefit under 35 U.S.C. § 119 (c) of U.S. Provisional Application Ser. No. 63/675,594 entitled ELASTOMERIC GAUGE WHEEL, filed Jul. 25, 2024, the entire contents of which are incorporated herein by reference for all purposes.

### BACKGROUND

Modern day agricultural planters are sophisticated machines. Planters place seeds into the soil at a precise depth and frequency, in many rows simultaneously as the machinery progresses down the field. A pivotal component of the planter is the gauge wheel. Gauge wheels essentially consist of a rim, which could be one or multiple pieces and a tire which contacts the ground and possibly a disc, used for opening a slot to place seeds in the soil. Each row of the planter has one or multiple gauge wheels. These wheels regulate the depth at which seeds are placed into the ground. The gauge wheels ride on top of the field surface and are subjected to harsh conditions due to debris and rocks left in the field from previous planting seasons, especially if the grower utilizes a “no-till” philosophy.

### SUMMARY

In some aspects, the techniques described herein relate to a gauge wheel tire, including: an elastomeric ground engaging portion; a first elastomeric sidewall portion attached to the elastomeric ground engaging portion; a second elastomeric sidewall portion attached to the elastomeric ground engaging portion; an elastomeric axial support portion attached to the first elastomeric sidewall portion and the second elastomeric sidewall portion opposite the elastomeric ground engaging portion, wherein the elastomeric ground engaging portion, the first elastomeric sidewall portion, the second elastomeric sidewall portion, and the elastomeric axial support portion define an annular cavity; and at least a first member, which is both flexible and resilient, positioned in the annular cavity and fixedly attached to the elastomeric ground engaging portion and/or the elastomeric axial support portion, wherein the first member: has a first surface and a second surface that faces away from the first surface, and is configured and arranged so that application of a force to the elastomeric ground engaging portion along a first line that intercepts and is perpendicular to an axis of rotation of the gauge wheel tire generates a compression force within the first member adjacent the first surface and a tension force within the first member adjacent the second surface.

In some aspects, the techniques described herein relate to a method for making a gauge wheel tire, including: forming a first elastomeric component including at least a first elastomeric sidewall portion of the gauge wheel tire, forming a second elastomeric component including at least a second elastomeric sidewall portion of the gauge wheel tire; and combining the first elastomeric component and the second elastomeric component to form an assembly including an elastomeric ground engaging portion and an elastomeric axial support portion, wherein: the elastomeric ground engaging portion is adapted to contact a ground surface as the gauge wheel tire rotates about an axis of rotation; the first elastomeric sidewall portion, the second elastomeric sidewall portion, the elastomeric ground engaging portion, and the elastomeric axial support portion define an annular cavity; and at least a first member, which is both flexible and resilient, is positioned in the annular cavity and fixedly attached to the elastomeric ground engaging portion and/or the elastomeric axial support portion, wherein the first member: has a first surface and a second surface that faces away from the first surface, and is configured and arranged so that application of a force to the elastomeric ground engaging portion along a first line that intercepts and is perpendicular to an axis of rotation of the gauge wheel tire generates a compression force within the first member adjacent the first surface and a tension force within the first member adjacent the second surface.

### BRIEF DESCRIPTION OF THE DRAWINGS

FIG. 1 shows a cutaway drawing of a conventional rubber gauge wheel tire;

FIG. 2 is a perspective view of an example agricultural planter on which a gauge wheel tire configured in accordance with the present disclosure may be deployed;

FIG. 3A is a perspective view of an example gauge wheel tire configured in accordance with the present disclosure;

FIG. 3B is a side view of the example gauge wheel tire shown in FIG. 3A;

FIG. 3C is bottom view of the example gauge wheel tire shown in FIG. 3A;

FIG. 4A is a cross-sectional view taken along the plane A-A shown in FIG. 3B;

FIG. 4B is a cross-sectional view taken along the plane B-B shown in FIG. 3B;

FIG. 4C is a cross-sectional view taken along the plane C-C shown in FIG. 3C;

FIG. 5 is a magnified view of the cross-sectional view shown in FIG. 4C;

FIG. 6A is a magnified view showing details of the internal structure of the disc side of the example gauge wheel shown in FIGS. 3A-C;

FIG. 6B is a magnified view showing details of the internal structure of the non-disc side of the example gauge wheel shown in FIGS. 3A-C;

FIG. 7A is a first conceptual diagram illustrating features of an example internal component of the example gauge wheel tire shown in FIGS. 3A-C before a force is applied to the ground engaging portion of the gauge wheel; and

FIG. 7B is a second conceptual diagram illustrating features of the internal component shown in FIG. 7A after a force is applied to the ground engaging portion of the gauge wheel tire.

### DETAILED DESCRIPTION

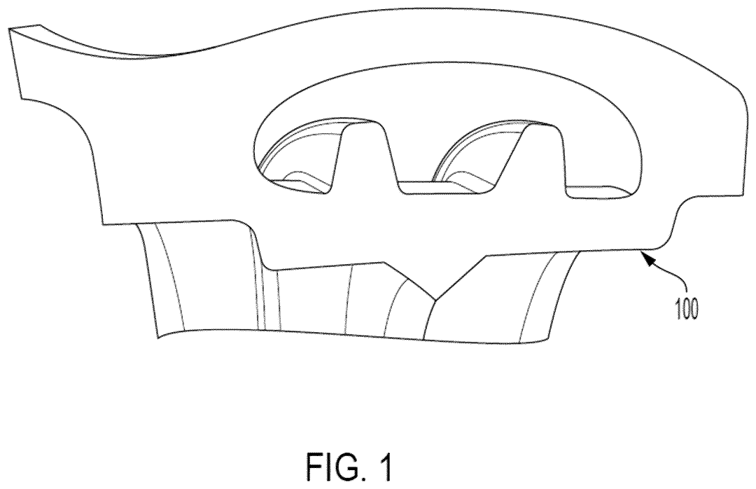

Conventional gauge wheel tires are made of a low modulus material, such as rubber, that is both flexible and resilient. A cutaway drawing of such a conventional rubber gauge wheel tire 100 is shown in FIG. 1. Recently, it has been discovered that the useful life of gauge wheels may be extended by utilizing materials other than rubber, such as cast polyurethane, particularly in no-till farming. Polyurethanes and other similar materials can be formulated for higher modulus than traditional rubber. The higher modulus materials may provide for a longer useful life because they are less likely to be punctured by field debris.

Some prior attempts to make gauge wheel tires with higher modulus materials have been inadequate because, due to their solid construction or other features, they cannot deflect appreciably. That is, the tires have been unable to flex like a traditional rubber gauge wheel tire. Flexing can be important because the flexing causes mud build-up to be ejected from the wheel, e.g., in wet field conditions. Furthermore, a flexible and compliant gauge wheel tire can reduce soil compaction. This can be important because soil compaction can lead to less than ideal growing conditions for a newly planted seed.

U.S. Pat. No. 11,970,031 (“the '031 patent”), owned by the same assignee as the instant application, describes a gauge wheel tire made of a higher modulus material that can flex appreciably in the radial direction and is also able to maintain its rigidity in the axial direction. Although the gauge wheel tires described in the '031 patent provide significant benefits, the inventors have recognized and appreciated that the radial spring rate of such gauge wheel tires, i.e., the amount of force required to move the ground engaging portion of the tire by a particular unit of distance relative to the axis of rotation (e.g., measured in pounds per inch or Newtons per meter), may not be ideal for some circumstances, and that additional control of the gauge wheel tire's radial spring rate could help maintain consistent seed depth in the planting operation. The inventors have further recognized and appreciated that with the multiple-piece gauge wheel tire described in the '031 patent, it can be challenging to create a robust and permanent connection between the joined parts because the design makes it difficult to apply an even force between the components when they are being joined together (e.g., during a friction welding operation).

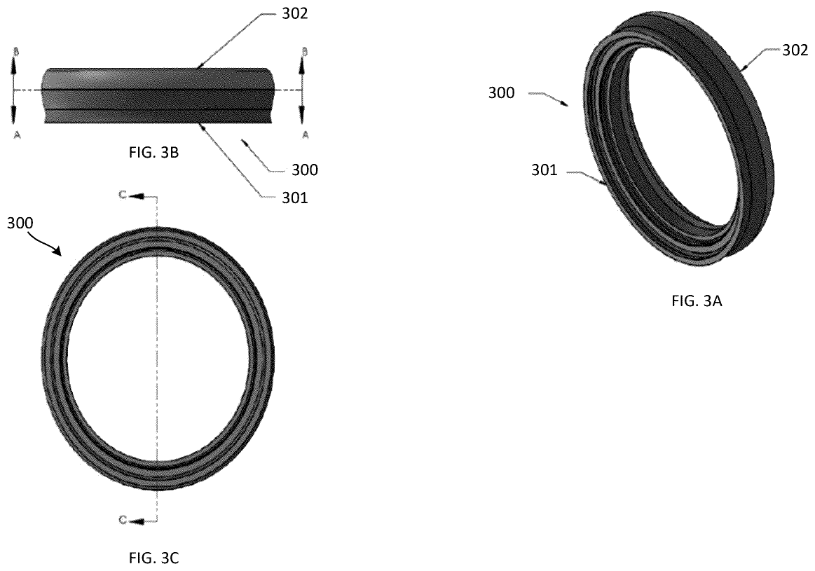

Offered is a gauge wheel tire similar to that described in the '031 patent but that employs additional features to better control the radial spring rate of the tire and that is configured to allow the application of an even force between the respective components of the tire when they are being joined together. Example implementations of gauge wheel tires 300 having such characteristics are described below in connection with FIGS. 3-7. Before describing those implementations, however, a brief description of an illustrative planting apparatus on which such tires may be employed will be provided.

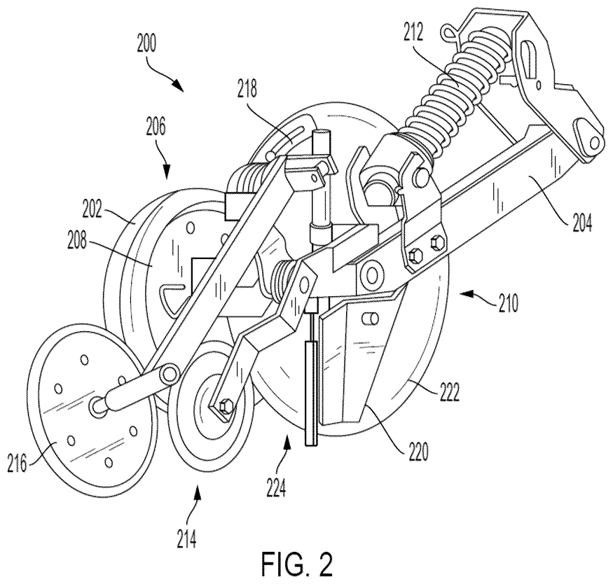

FIG. 2 illustrates a perspective view of a portion of an agricultural planter 200 with which a gauge wheel tire 202 configured in accordance with the present disclosure may be employed. As shown, the agricultural planter 200 may include an arm 204 that supports a gauge wheel 206. As described in more detail below, the gauge wheel 206 may be formed by mounting a gauge wheel tire 202 on one or more rims 208. A disc or knife 210 may be coupled to the planter arm 204. The disc or knife 210 may engage and open soil, creating a furrow for the receipt of seeds, seedlings, or other plants to be planted by the planter 200. The arm 204 may also support a pressure adjustment member 212 for adjusting the downward pressure that is applied to the disc or knife 210 engaging the soil to facilitate consistent seed placement.

A seed firming wheel 214 may be coupled to arm 204. The seed firming wheel 214 may gently pack a seed, seedling, or other plant to be planted at the bottom of the furrow. A packer wheel 216 may be coupled to arm 204 in order to close the furrow after seed placement. A depth control assembly 218 may be coupled to the arm 204 to enable the making of depth adjustments to the seeding depth.

A scraper 220 may be provided on a first side 222 of the disc or knife 210. The scraper 220 may be coupled to the arm 204 to protect against plugging, while additionally acting as a seed boot, thus creating a shelf for accurate seed placement in the furrow. As illustrated, the gauge wheel 206 may be provided on a second side 224 of the disc. The rim(s) 208 may carry the gauge wheel tire 202 which engages or rolls over the soil or ground. In addition, the gauge wheel tire 202 may contact the second side 224 of the disc or knife 210, creating a cleaning action to facilitate removal of debris deposited on the disc during planting operations.

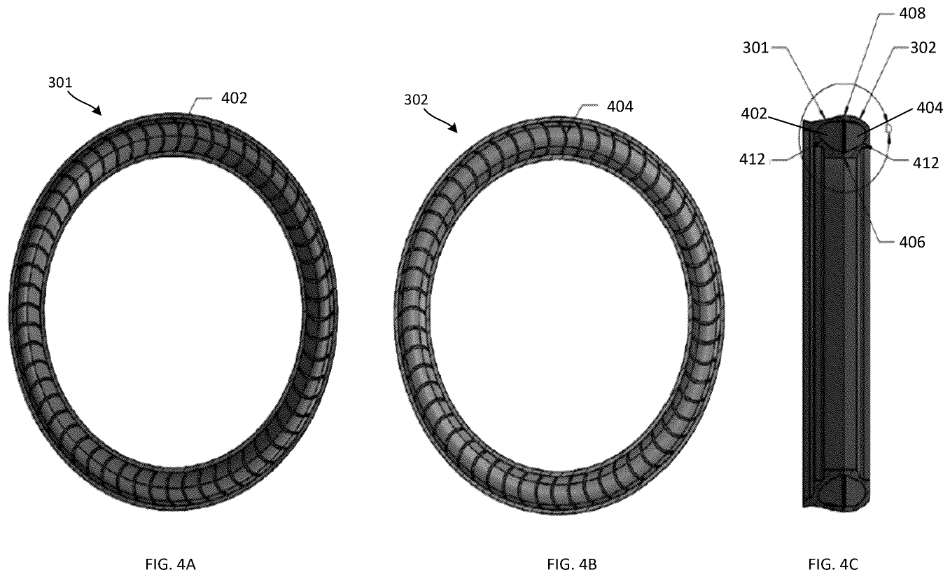

An example gauge wheel tire 300 configured in accordance with the present disclosure will now be described with reference to FIGS. 3A-C, 4A-C, 5, and 6A-B. In some implementations, the gauge wheel tire 300 may comprise multiple, individually constructed pieces combined into a final assembly. In the illustrated example, the gauge wheel tire 300 (illustrated in its assembled state in FIGS. 3A-C) includes multiple, individually manufactured sections including a disc side 301 (illustrated separately in FIG. 4A) and a non-disc side 302 (illustrated separately in FIG. 4B).

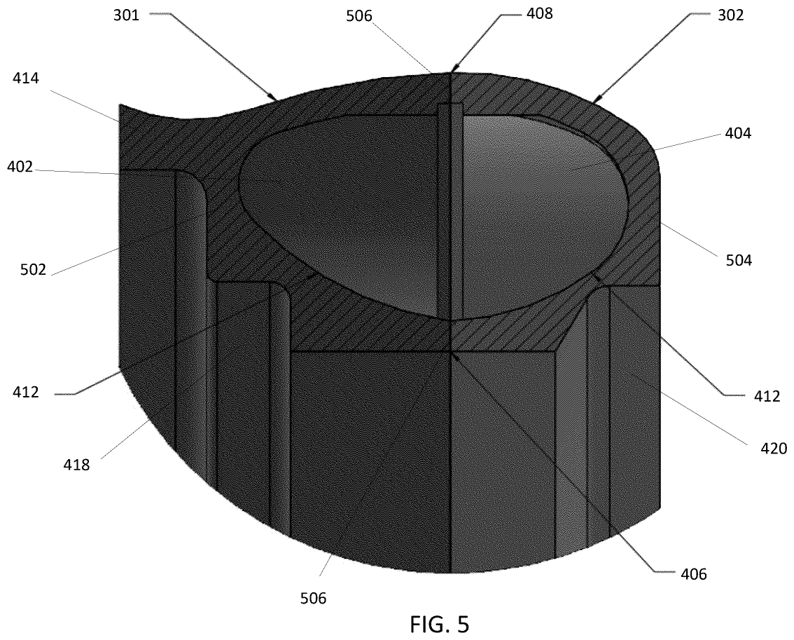

Referring to FIG. 5, the disc side 301 and the non-disc side 302 may provide at least some amount of rigidity in the axial direction (e.g., due an axial support portion 406) between a first sidewall portion 502 of the disc side 301 and a second sidewall portion 504 of the non-disc side 302, while at the same time allowing at least some degree of flexibility of a ground engaging portion 408 of the tire 300 in the radial direction, e.g., due to the presence of a hollow cavity 412 between the non-disc side 302 and the disc side 301. It should also be appreciated that, in some implementations, the disc side 301 and the non-disc side 302 may have one or more regions of reduced thickness and/or one or more regions including openings at locations at which structural integrity is not essential, thus minimizing the amount of material that is used for manufacture.

In implementations that employ individually manufactured (e.g., molded) sections 301, 302, such sections may be constructed using materials with the same or different moduli and/or the same or different chemical make-up. It is important only that the individual pieces be constructed in such a way that is conducive to the final assembly process. In some implementations, the final assembly of the gauge wheel tire 300 may resemble the profile and outer envelope of a traditional, rubber gauge wheel design, such as that shown in FIG. 1.

As shown in FIGS. 4A, 5, and 6A, in some implementations, the disc side 301 may be manufactured (e.g., molded) to include internal members 402 which may control the radial spring rate of the gauge wheel tire 300, as described in more detail below. Similarly, as shown in FIGS. 4B, 5, and 6B, in some implementations, the non-disc side 302 may likewise be manufactured (e.g., molded) to include internal members 404 which may control the radial spring rate of the gauge wheel tire 300.

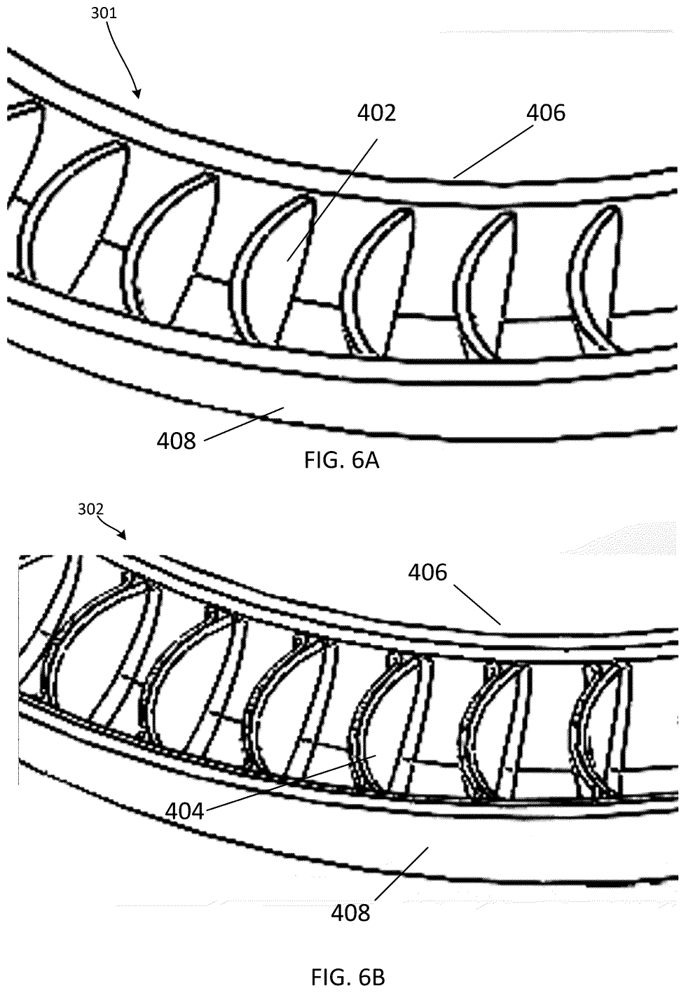

As shown best in FIGS. 6A and 6B, in some implementations, the internal members 402, 404 may have a shape resembling a portion of a potato chip and may each extend from the axial support portion 406 to the ground engaging portion 408 of the gauge wheel tire 300 to enable them to control the radial spring rate of the gauge wheel tire 300 as it rolls over rugged terrain.

In some implementations, the gauge wheel tire 300 may be manufactured (e.g., injection molded) using a method that allows for the formation of a completely enclosed hollow cavity 412 which may allow the gauge wheel tire 300 to flex in the radial direction, while maintaining its rigidity in the axial direction. In some implementations, the manufacturing method may allow for the inclusion of the internal members 402, 404 which may be configured and arranged to consistently control the radial spring rate of the gauge wheel tire 300. In some implementations, the radial spring rate of the gauge wheel tire 300 may be controlled, for example, by adjusting the quantity of the internal members 402, 404, the thickness of the internal members 402, 404, and/or the radius of curvature of the internal members 402, 404. The radial spring rate may additionally or alternatively be controlled by adjusting the wall thickness of the disc side 301 and/or non-disc side 302.

In some implementations, some or all of the internal members 402, 404 may be fixedly attached to the respective sides (e.g., the disc side 301 and the non-disc side 302) of the gauge wheel tire 300 by being manufactured (e.g., molded) together with the respective sides. In other implementations, some or all of the internal members 402, 404 may additionally or alternatively be manufactured (e.g., molded) separately from the disc side 301 and/or the non-disc side 302 and subsequently fixedly attached to one or both of those components (e.g., using an adhesive, mechanical fastener, or friction or heat welding technique) before the disc side 301 and the non-disc side 302 are joined together at joining surfaces 506 (see FIG. 5). In either case, the internal members 402, 404 may be attached to the respective sides (e.g., the disc side 301 and the non-disc side 302) of the gauge wheel tire 300 in such a way that the internal members 402, 404 cannot be removed from those components without damaging either the internal members 402, 404 or the components to which they are attached (i.e., the disc side 301 or the non-disc side 302).

In other implementations, not shown, the gauge wheel tire 300 may be manufactured with an upper portion and a lower portion, similar to the design shown in the '031 patent. As described in '031 patent, the entire contents of which are incorporated herein by reference, the upper portion may include a ground engaging portion and the lower portion may include an axial support portion. The upper portion and lower portion may be coupled together to form a first sidewall, a second sidewall, and a hollow cavity enclosed by the ground engaging portion, the axial support portion, the first sidewall, and the second sidewall. In some implementations, the upper portion in such a design may include a set of internal members (similar to the internal members 402, 404 described herein) fixedly attached to the upper portion, e.g., by being glued or welded to the upper portion or manufactured (e.g., molded) together with the upper portion. Additionally or alternatively, the lower portion may likewise include a set of internal members (similar to the internal members 402, 404 described herein) fixedly attached to the lower portion, e.g., by being glued or welded to the lower portion or manufactured (e.g., molded) together with the lower portion. In some implementations, the upper portion and the lower portion may be joined together (e.g., by rotational molding or using an adhesive), thus forming a scam along the sides of the gauge wheel tire 300. Similar to the gauge wheel tire 300, the internal members in such a design may be used to control the radial spring rate of the gauge wheel tire.

As shown best in FIG. 5, in some implementations, the gauge wheel tire 300 may include a flange 414 on at least one side that forms a generally flat region for contacting and cleaning debris from a disc or knife 210 of an agricultural planter 200, as described above in connection with FIG. 2. As also shown in FIG. 5, in some implementations, the disc side 301 may include a flange that forms an annular cavity 418 that is shaped to engage corresponding portions of one or more circular gauge wheel tire rims 208 (shown in FIG. 2). In other implementations, the non-disc side 302 may additionally include an annular cavity 420 that is shaped to engage corresponding portions of one or more circular gauge wheel tire rims 208 (shown in FIG. 2).

In some implementations, the disc side 301 and/or non-disc side 302 may be formed using elastomeric materials with a hardness of approximately 92 Shore A. Such a material has been found to provide a satisfactory balance between puncture resistance from field debris and overall flexibility of the assembly. Elastomeric materials softer than 92 Shore A, such as 90 Shore A, 85 Shore A, 80 Shore A, 75 Shore A or 70 Shore A, and/or elastomeric materials harder than 92 Shore A, such as 95 Shore A, 50 Shore D, 55 Shore D, 60 Shore D or 65 Shore D may additionally or alternatively be used for either or both of the non-disc side 302 and the disc side(s) 301.

The individual pieces of the gauge wheel tire assembly 300 may be constructed using any of a number of elastomers. Examples of suitable materials include hot castable, room temperature castable or thermoplastic injection moldable polyurethanes, such as MDI polyurethane, TDI polyurethane, or PPDI polyurethane. An MDI polyurethane may include methylene diphenyl diisocyanate reacted with a polyester or polyether polyol. In some implementations, 1,4 butanediol may be employed as a chain extender to cure an MDI based polyurethane. In other implementations, other diols may additionally or alternatively be used as a chain extender. A TDI polyurethane may include toluene diisocyanate reacted with a polyester or polyether polyol. In some implementations, 4,4′ methylenebis(2-chloroaniline) may be employed as a chain extender to cure a TDI based polyurethane. In other implementations, other diamines, such as Dimethylthiotoluenediamine or Methylene bis(2,6-diethyl-3-chloroaniline), may additionally or alternatively be used as a chain extender. A PPDI polyurethane may include p-phenylenediisocyanate reacted with a polyester or polyether polyol. In some implementations, 1,4 butanediol may be employed as a chain extender to cure an PPDI based polyurethane. In other implementations, other diols may additionally or alternatively be used as a chain extender. For MDI-based, TDI-based, or PPDI based polyurethanes, additives may also be added to the polyurethane compound in order to tailor select polyurethane material properties. For example, additives such as internal lubricants may be added to increase sliding abrasion resistance.

Other elastomeric material families may additionally or alternatively be used to construct one or more of the individual pieces of the final gauge wheel tire assembly 300. Example of such families include: Thermoplastic Rubber (TPR), Thermoplastic Elastomer (TPE), Thermoplastic Vulcanizates (TPV), Polyamide, Polyethylene, Polypropylene, Polyoxymethylene, or Polychloroprene. Additives may be added to any of these elastomeric material families in order to tailor select properties to meet the requirements of the application.

The individual pieces of the gauge wheel tire assembly 300 may be manufactured in a variety of ways. Examples of suitable manufacturing methods include casting, injection molding, transfer molding, compression molding, machining from billets, or additive manufacturing.

There are many different methods that may be utilized for combining the individual pieces of the final assembly of the novel gauge wheel tire design described herein. One way the individual pieces may be combined into a final assembly is through the use of an adhesive. Commercially available epoxy resins, such as Epon 828, available from Hexion Company of Columbus, Ohio, when cross-linked with appropriate curatives such as Versamid 140, available from BASF, headquartered in Ludwigshafen, Germany, can form a robust joint between the individual pieces of the final assembly. The joining surfaces 506 (shown best in FIG. 5) should preferably be prepared prior to assembly with such an adhesive to remove any impurities or lubricants that might reduce the adherence between the adhesive and the joining surfaces 506.

Another suitable method for combining the individual pieces into a final assembly involves the use of mechanical fasteners. The joining surfaces 506 and surrounding areas of the individual components may, for example, be altered such that commercially available mechanical fasteners can be used to hold the mating surfaces of the final assembly against one another securely.

Yet another suitable method for combining the individual pieces into the final assembly involves the use of thermal welding. Thermoplastic materials may be heated to a melting point, such that they will become a viscous liquid. When the heat source is removed, the thermoplastic materials will cool and phase change back into solids. If two adjacent surfaces are heated, such that both phase change to viscous liquids and the melted material from the two surfaces is combined, when the heat source is removed the two surfaces will become one. In some implementations, friction may be used as the heat source to cause such melting. An individual component of the final gauge wheel tire assembly may be held against another individual component of the final gauge wheel tire assembly. By moving the two individual components relative to one another, either by simultaneously moving both components or by holding one component stationary while moving the other, friction between the mating surfaces will result in the generation of heat. The heat generated by the friction may be made high enough to cause the joining surfaces 506 of the individual gauge wheel components to melt and combine. When the relative movement is stopped, friction is no longer generated, thus allowing the parts to cool and become one integral component. In some implementations, the non-disc side 302 may be spun relative to the disc side 301, or vice versa, so as to cause such thermal welding to occur.

It should be appreciated that the particular configuration of the gauge wheel tire 300 allows the disc side 301 to be pressed against the non-disc side 302 to provide pressure uniformly between the joining surfaces 506 of those components as one component is rotated relative to the other or while an adhesive between the components is being allowed to cure, thus improving the quality of the connection that can be established between the respective components. It should also be appreciated that use of any of the above-described joining techniques may result in at least one seam being formed between the respective components at the joining surfaces 506. Such seam(s) may, for example, comprise an adhesive material, a physical contact region between the joining surfaces 506, a thermal welding joint, etc.

It should also be appreciated that, in various implementations, the joining surfaces 506 may be configured in any of numerous different ways. The optimal configuration may be determined, for example, based on various parameters including, but not limited to, the type of process by which the joining surfaces 506 will be joined and/or the material(s) being used for the gauge wheel tire 300. In some implementations, the joining surfaces 506 may be configured in such a way that increases the amount of surface area between them. For instance, one of the joining surfaces 506 may include a male interlocking feature and the opposite joining surface 506 may include a female interlocking feature. The interlocking features may allow for the joining surfaces 506 to include more surface area which may create a stronger adhesive force between the disc side 301 and the non-disc side 302. As another example, in some implementations, the joining surfaces 506 may each be flat, as shown in FIG. 5, which may allow for even heating across the contacting surfaces when friction welding at the joining surfaces 506.

In some implementations, the hollow cavity 412 (see FIG. 5) may additionally be filled with a spring-like material or multiple spring-like materials such as open or closed cell foam of various flexible materials, gas-filled rubber tubing, plastic springs, metallic springs or solid elastomeric tubing to adjust the flexibility of the gauge wheel as desired.

As shown best in FIGS. 6A-B, in some implementations, the internal members 402, 404 may be configured and arranged to control the radial spring rate of the gauge wheel tire 300. For instance, the radial spring rate of the tire 300 may be adjusted by altering the radius of curvature of the internal members 402, 404. In some implementations, the radius of curvature may be positive or negative, e.g., convex or concave. In other implementations, not shown, there may be no curvature in the internal members 402, 404. For instance, the internal members 402, 404 may be manufactured such that they extend straight into the cavity 412 from the disc side 301 or the non-disc side 302. It can be appreciated that the internal members 402, 404 may be any suitable shape that can control the spring rate of the ground engaging portion relative to the axis of rotation of the tire 300.

In some implementations, the radial spring rate of the ground engaging portion 408 may be controlled based on the placement of the internal members 402, 404 within the hollow cavity 412. In various implementations, the internal members 402, 404 may be fixedly attached to and/or extend between the ground engaging portion 408 and the axial support portion 424 at any of a number of locations and in any of a number of ways that causes the radial spring rate of the ground engaging portion 408 to be controlled. In some implementations, for example, the internal members 402, 404 may be fixedly attached to any one of, or extend between any two or more of, the axial support portion 424, the ground engaging portion 408, the first sidewall portion 502, and the second sidewall portion 504. As the ground engaging portion 408 deflects, the internal members 402, 404 may resist the compression force by bending within the hollow cavity 412 and providing a resistance force opposite the compression force to control the radial spring rate of the ground engaging portion 408. In some implementations, the radial spring rate of the ground engaging portion 408 may be further controlled, at least in part, by altering the shape, material, and/or thickness of the internal members 402, 404.

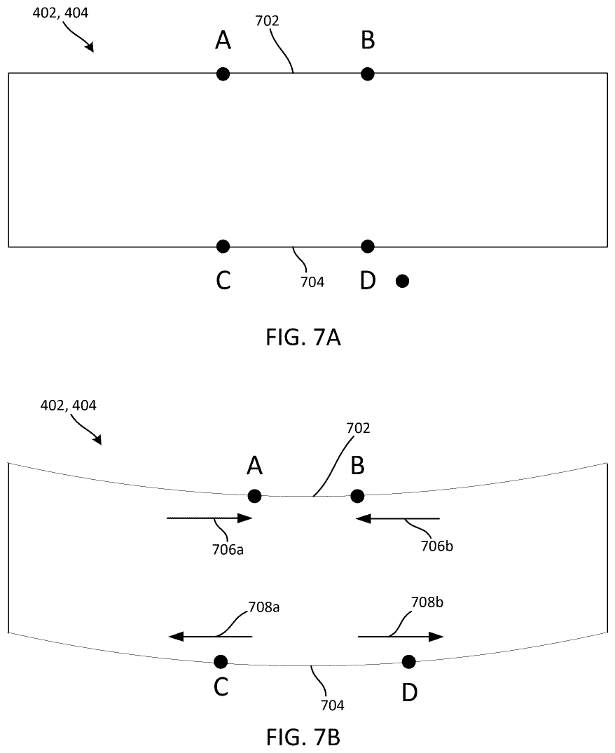

FIGS. 7A-B illustrate conceptually how an internal member 402, 404 may be used to control the radial spring rate of the ground engaging portion 408 of the gauge wheel tire 300. As illustrated, in some implementations, the internal member 402, 404 may be configured to have a first surface 702 and a second surface 704 that faces away from the first surface 702. As shown, points “A” and “B” may be located on the first surface 702 and points “C” and “D” may be located on the second surface 704. The internal member 402, 404 may be positioned within the cavity 412 of the gauge wheel tire 300 such that the application of a force to the ground engaging portion 408 along a line that intercepts and is perpendicular to the axis of rotation of the gauge wheel tire 300, causes the internal member 402, 404 to bend or otherwise elastically deform within the cavity 412, e.g., as illustrated conceptually in FIG. 7B.

As shown in FIG. 7B, such bending/deformation of the internal member 402, 404 may cause the point A to move closer to the point B and, as illustrated by arrows 706a and 706b, may cause a compression force to be generated within the internal member 402, 404 adjacent the first surface 702. As also shown in FIG. 7B, such bending/deformation of the internal member 402, 404 may cause the point C to move further away from the point D and, as illustrated by arrows 708a and 708b, may cause a tension force to be generated within the internal member 402, 404 adjacent the second surface 704. Such compression and tension forces within the respective internal members 402, 404, will thus counteract the radial force being applied to the ground engaging portion 408 and effectively regulate the radial spring rate of the gauge wheel tire 300. The internal members 402, 404 may thus be manufactured and positioned within the cavity 412 such that the compression and tension forces they experience when a radial force is applied to the ground engaging portion 408 ensures that the radial spring rate of the gauge wheel tire 300 is appropriate for its contemplated end use.

From the above discussion, it can be appreciated that the internal members 402, 404 effectively behave as springs within the hollow cavity 412 of the gauge wheel tire 300. The internal members 402, 404 may be designed to control the deflection of the ground engaging portion 408 as a force is applied to the it. The internal members 402, 404 may inhibit deflection of the ground engaging portion 408 by providing a resistance to the force being applied to it. Once there is no longer a force being applied to the ground engaging portion 408, the internal members 402, 404 may cause the gauge wheel tire 300 to return to its original shape. The internal members 402, 404 may apply a force to the ground engaging portion 408 in the opposite direction as the compression force to ensure that the gauge wheel tire 300 returns to its original shape when under no compression force. In some implementations, as the internal members 402, 404 are bent or otherwise deformed, they may accumulate potential energy. When the compression force is removed, the potential energy stored in the internal members 402, 404 may be released as kinetic energy and push the ground engaging portion 408 back to its original position.

The following clauses describe example implementations of the present disclosure.

Clause 1. A gauge wheel tire, comprising: an elastomeric ground engaging portion; a first elastomeric sidewall portion attached to the elastomeric ground engaging portion; a second elastomeric sidewall portion attached to the elastomeric ground engaging portion; an elastomeric axial support portion attached to the first elastomeric sidewall portion and the second elastomeric sidewall portion opposite the elastomeric ground engaging portion, wherein the elastomeric ground engaging portion, the first elastomeric sidewall portion, the second elastomeric sidewall portion, and the elastomeric axial support portion define an annular cavity; and at least a first member, which is both flexible and resilient, positioned in the annular cavity and fixedly attached to the elastomeric ground engaging portion and/or the elastomeric axial support portion, wherein the first member: has a first surface and a second surface that faces away from the first surface, and is configured and arranged so that application of a force to the elastomeric ground engaging portion along a first line that intercepts and is perpendicular to an axis of rotation of the gauge wheel tire generates a compression force within the first member adjacent the first surface and a tension force within the first member adjacent the second surface.

Clause 2. The gauge wheel tire of clause 1, wherein the first member is fixedly attached to both the elastomeric ground engaging portion and the elastomeric axial support portion.

Clause 3. The gauge wheel tire of clause 1, wherein the first member is fixedly attached to the first elastomeric sidewall portion.

Clause 4. The gauge wheel tire of clause 1, wherein: there is a first seam between respective portions of the elastomeric ground engaging portion; and there is a second seam between respective portions of the elastomeric axial support portion.

Clause 5. The gauge wheel tire of clause 4, wherein: the first seam comprises a first thermal welding joint; and the second seam comprises a second thermal welding joint.

Clause 6. The gauge wheel tire of clause 4, wherein: the first seam comprises a first adhesive material; and the second seam comprises a second adhesive material.

Clause 7. The gauge wheel tire of clause 1, wherein the elastomeric axial support portion includes at least one flange that defines an annular cavity adapted to receive a circular gauge wheel rim.

Clause 8. The gauge wheel tire of clause 1, wherein a hardness of at least the elastomeric ground engaging portion is between 85 Shore A and 95 Shore A.

Clause 9. The gauge wheel tire of clause 1, further comprising a second member, which is both flexible and resilient, positioned in the annular cavity and fixedly attached to the elastomeric ground engaging portion and/or the elastomeric axial support portion, wherein the second member: has a third surface and a fourth surface that faces away from the third surface, and is configured and arranged so that application of the force to the elastomeric ground engaging portion along a second line that intercepts and is perpendicular to the axis of rotation of the gauge wheel tire generates a compression force within the second member adjacent the third surface and a tension force within the second member adjacent the fourth surface.

Clause 10. The gauge wheel tire of clause 9, wherein: the first member is fixedly attached to the first elastomeric sidewall portion, and the second member is fixedly attached to the second elastomeric sidewall portion.

Clause 11. The gauge wheel tire of clause 1, further comprising an elastomeric protrusion portion extending axially from the first elastomeric sidewall portion, the elastomeric protrusion portion including a generally flat region adapted to contact and clean debris from a disc or knife of an agricultural planter.

Clause 12. A method for making a gauge wheel tire, comprising: forming a first elastomeric component including at least a first elastomeric sidewall portion of the gauge wheel tire, forming a second elastomeric component including at least a second elastomeric sidewall portion of the gauge wheel tire; and combining the first elastomeric component and the second elastomeric component to form an assembly including an elastomeric ground engaging portion and an elastomeric axial support portion, wherein: the elastomeric ground engaging portion is adapted to contact a ground surface as the gauge wheel tire rotates about an axis of rotation; the first elastomeric sidewall portion, the second elastomeric sidewall portion, the elastomeric ground engaging portion, and the elastomeric axial support portion define an annular cavity; and at least a first member, which is both flexible and resilient, is positioned in the annular cavity and fixedly attached to the elastomeric ground engaging portion and/or the elastomeric axial support portion, wherein the first member: has a first surface and a second surface that faces away from the first surface, and is configured and arranged so that application of a force to the elastomeric ground engaging portion along a first line that intercepts and is perpendicular to an axis of rotation of the gauge wheel tire generates a compression force within the first member adjacent the first surface and a tension force within the first member adjacent the second surface.

Clause 13. The method of clause 12, wherein: forming the first elastomeric component comprises curing a first quantity of polyurethane material in a shape of the first elastomeric component; and forming the second elastomeric component comprises curing a second quantity of polyurethane material in a shape of the second elastomeric component.

Clause 14. The method of clause 12, wherein the first elastomeric component is formed to include a protrusion extending axially from the first elastomeric sidewall portion, the protrusion including a generally flat region adapted to contact and clean debris from a disc or knife of an agricultural planter.

Clause 15. The method of clause 12, wherein a hardness of at least the first elastomeric component is between 85 Shore A and 95 Shore A.

Clause 16. The method of clause 15, wherein a hardness of the second elastomeric component is between 85 Shore A and 95 Shore A.

Clause 17. The method of clause 12, wherein combining the first elastomeric component and the second elastomeric component comprises thermal welding the first elastomeric component and the second elastomeric component into the assembly.

Clause 18. The method of clause 17, wherein thermal welding the first elastomeric component and the second elastomeric component into the assembly includes: moving the first elastomeric component relative to the second elastomeric component to generate friction that melts contacting portions of the first elastomeric component and the second elastomeric component.

Clause 19. The method of clause 12, wherein: the first elastomeric component includes a first surface having a first circular shape; the second elastomeric component includes a second surface having a second circular shape that matches the first circular shape; and combining the first elastomeric component and the second elastomeric component includes joining the first surface to the second surface.

Clause 20. The method of clause 12, wherein the first member is fixedly attached to the first elastomeric component before the first elastomeric component is combined with the second elastomeric component.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A gauge wheel tire, comprising:
an elastomeric ground engaging portion;
a first elastomeric sidewall portion attached to the elastomeric ground engaging portion;
a second elastomeric sidewall portion attached to the elastomeric ground engaging portion;
an elastomeric axial support portion attached to the first elastomeric sidewall portion and the second elastomeric sidewall portion opposite the elastomeric ground engaging portion, wherein the elastomeric ground engaging portion, the first elastomeric sidewall portion, the second elastomeric sidewall portion, and the elastomeric axial support portion define an annular cavity; and
at least a first member, which is both flexible and resilient, positioned in the annular cavity and fixedly attached to the elastomeric ground engaging portion and/or the elastomeric axial support portion, wherein the first member:
has a first surface and a second surface that faces away from the first surface, and
is configured and arranged so that application of a force to the elastomeric ground engaging portion along a first line that intercepts and is perpendicular to an axis of rotation of the gauge wheel tire generates a compression force within the first member adjacent the first surface and a tension force within the first member adjacent the second surface.

2. The gauge wheel tire of claim 1, wherein the first member is fixedly attached to both the elastomeric ground engaging portion and the elastomeric axial support portion.

3. The gauge wheel tire of claim 1, wherein the first member is fixedly attached to the first elastomeric sidewall portion.

4. The gauge wheel tire of claim 1, wherein:
there is a first seam between respective portions of the elastomeric ground engaging portion; and
there is a second seam between respective portions of the elastomeric axial support portion.

5. The gauge wheel tire of claim 4, wherein:
the first seam comprises a first thermal welding joint; and
the second seam comprises a second thermal welding joint.

6. The gauge wheel tire of claim 4, wherein:
the first seam comprises a first adhesive material; and
the second seam comprises a second adhesive material.

7. The gauge wheel tire of claim 1, wherein the elastomeric axial support portion includes at least one flange that defines an annular cavity adapted to receive a circular gauge wheel rim.

8. The gauge wheel tire of claim 1, wherein a hardness of at least the elastomeric ground engaging portion is between 85 Shore A and 95 Shore A.

9. The gauge wheel tire of claim 1, further comprising a second member, which is both flexible and resilient, positioned in the annular cavity and fixedly attached to the elastomeric ground engaging portion and/or the elastomeric axial support portion, wherein the second member:
has a third surface and a fourth surface that faces away from the third surface, and
is configured and arranged so that application of the force to the elastomeric ground engaging portion along a second line that intercepts and is perpendicular to the axis of rotation of the gauge wheel tire generates a compression force within the second member adjacent the third surface and a tension force within the second member adjacent the fourth surface.

10. The gauge wheel tire of claim 9, wherein:
the first member is fixedly attached to the first elastomeric sidewall portion, and
the second member is fixedly attached to the second elastomeric sidewall portion.

11. The gauge wheel tire of claim 1, further comprising an elastomeric protrusion portion extending axially from the first elastomeric sidewall portion, the elastomeric protrusion portion including a generally flat region adapted to contact and clean debris from a disc or knife of an agricultural planter.

12. A method for making a gauge wheel tire, comprising:
forming a first elastomeric component including at least a first elastomeric sidewall portion of the gauge wheel tire,
forming a second elastomeric component including at least a second elastomeric sidewall portion of the gauge wheel tire; and
combining the first elastomeric component and the second elastomeric component to form an assembly including an elastomeric ground engaging portion and an elastomeric axial support portion, wherein:
the elastomeric ground engaging portion is adapted to contact a ground surface as the gauge wheel tire rotates about an axis of rotation;
the first elastomeric sidewall portion, the second elastomeric sidewall portion, the elastomeric ground engaging portion, and the elastomeric axial support portion define an annular cavity; and
at least a first member, which is both flexible and resilient, is positioned in the annular cavity and fixedly attached to the elastomeric ground engaging portion and/or the elastomeric axial support portion, wherein the first member:
has a first surface and a second surface that faces away from the first surface, and
is configured and arranged so that application of a force to the elastomeric ground engaging portion along a first line that intercepts and is perpendicular to an axis of rotation of the gauge wheel tire generates a compression force within the first member adjacent the first surface and a tension force within the first member adjacent the second surface.

13. The method of claim 12, wherein:
forming the first elastomeric component comprises curing a first quantity of polyurethane material in a shape of the first elastomeric component; and
forming the second elastomeric component comprises curing a second quantity of polyurethane material in a shape of the second elastomeric component.

14. The method of claim 12, wherein the first elastomeric component is formed to include a protrusion extending axially from the first elastomeric sidewall portion, the protrusion including a generally flat region adapted to contact and clean debris from a disc or knife of an agricultural planter.

15. The method of claim 12, wherein a hardness of at least the first elastomeric component is between 85 Shore A and 95 Shore A.

16. The method of claim 15, wherein a hardness of the second elastomeric component is between 85 Shore A and 95 Shore A.

17. The method of claim 12, wherein combining the first elastomeric component and the second elastomeric component comprises thermal welding the first elastomeric component and the second elastomeric component into the assembly.

18. The method of claim 17, wherein thermal welding the first elastomeric component and the second elastomeric component into the assembly includes:
moving the first elastomeric component relative to the second elastomeric component to generate friction that melts contacting portions of the first elastomeric component and the second elastomeric component.

19. The method of claim 12, wherein:
the first elastomeric component includes a first surface having a first circular shape;
the second elastomeric component includes a second surface having a second circular shape that matches the first circular shape; and
combining the first elastomeric component and the second elastomeric component includes joining the first surface to the second surface.

20. The method of claim 12, wherein the first member is fixedly attached to the first elastomeric component before the first elastomeric component is combined with the second elastomeric component.
